(19) United States
(12) Patent Application Publication
(10) Pub. No.: US 2023/0175621 A1
(43) Pub. Date: Jun. 8, 2023

(54) INNER RING AND PIPE JOINT

(71) Applicant: NIPPON PILLAR PACKING CO., LTD.,, Osaka (JP)

(72) Inventors: Ayumi KUROSAKI, Osaka (JP); Shingo HIGUCHI, Osaka (JP); Kazukiyo TESHIMA, Osaka (JP)

(73) Assignee: NIPPON PILLAR PACKING CO., LTD.,, Osaka (JP)

(21) Appl. No.: 17/924,215

(22) PCT Filed: Mar. 31, 2021
(86) PCT No.: PCT/JP2021/014020

§ 371 Date: Nov. 9, 2022

(30) Foreign Application Priority Data
Jul. 14, 2020 (JP) 2020-120535

(51) Int. Cl. F16L 33/22

(52) U.S. Cl. CPC F16L 33/222; F16L 33/223; F16L 19/07

(57) ABSTRACT

An inner ring 4 of a pipe joint 1 includes a bulge portion 6 formed at an axially outer end portion thereof so as to project toward a radially outer side, and to be press-fitted into an end portion of a tube 8, and has a fluid flow passage 4a formed on a radially inner side of the bulge portion 6. The bulge portion 6 is formed so as to be tapered from an axially inner side toward an axially outer end thereof in an axial cross-sectional view, and has a flat surface 6e formed at the axially outer end thereof and extending in a radial direction.

### TECHNICAL FIELD

The present invention relates to an inner ring and a pipe joint.

### BACKGROUND ART

In manufacturing processes in various technical fields such as semiconductor manufacturing, medical/pharmaceutical manufacturing, and food processing/chemical industries, in a pipe path through which fluids such as chemical solutions, high-purity liquids, ultrapure water, or cleaning solutions flow, for example, a pipe joint made of a synthetic resin is used as a connection structure that connects flow passages formed in tubes or fluid devices. As such a pipe joint, a pipe joint that includes an inner ring mounted on the inner circumferential side of an end portion of a tube, a cylindrical joint body mounted on the outer circumferential side of the end portion of the tube, and a union nut mounted on the outer circumferential side of the joint body, is known (see, for example, PATENT LITERATURE 1).

The inner ring has a cylindrical body portion, a bulge portion formed at one axial end portion of the body portion so as to project toward a radially outer side, and a sealing portion formed at another axial end portion of the body portion. A fluid flow passage is formed inside the inner ring. The bulge portion of the inner ring is press-fitted into the end portion of the tube to increase the diameter of the end portion of the tube. The union nut is attached to the joint body, and presses the outer circumferential surface of the tube whose diameter has been increased by the bulge portion of the inner ring. Accordingly, the sealing portion of the inner ring is pressed into a sealing groove formed on the joint body.

### CITATION LIST

### Patent Literature

PATENT LITERATURE 1: Japanese Laid-Open Patent Publication No. 2018-168947

### SUMMARY OF THE INVENTION

### Technical Problem

A cross-sectional shape of the bulge portion in the inner ring is formed so as to be gradually tapered from an axial center portion thereof toward the axially outer end thereof, and the axially outer end of the bulge portion is sharply formed, so that the thickness in the radial direction of the bulge portion is the thinnest at the axially outer end thereof. Therefore, when the union nut presses the diameter-increased portion of the tube, an axially outer end portion of the bulge portion may become deformed so as to fall down (protrude) toward the radially inner side (fluid flow passage side) due to insufficient strength. When such falling down occurs, a gap is formed between the contact surfaces of the axially outer end portion of the bulge portion and the tube due to insufficient surface pressure between the contact surfaces. As a result, the fluid enters the gap between the contact surfaces and remains therein, which reduces the replacement characteristics of the fluid flowing through the pipe path, causing adverse effects such as taking time for flushing the pipe path.

The present invention has been made in view of such circumstances, and an object of the present invention is to provide an inner ring and a pipe joint that can inhibit an axially outer end portion of a bulge portion from falling down toward a radially inner side.

### Solution to Problem

(1) An inner ring of the present invention is an inner ring including a bulge portion formed at an axially outer end portion thereof so as to project toward a radially outer side, and to be press-fitted into an end portion of a tube, the inner ring having a fluid flow passage formed on a radially inner side of the bulge portion, wherein the bulge portion is formed so as to be tapered from an axially inner side toward an axially outer end thereof in an axial cross-sectional view, and has a flat surface formed at the axially outer end thereof and extending in a radial direction.

In the inner ring of the present invention, the bulge portion which is formed so as to be tapered from the axially inner side toward the axially outer end thereof has the flat surface formed at the axially outer end thereof and extending in the radial direction, so that the thickness in the radial direction at the axially outer end of the bulge portion can be larger than that in the conventional art. Accordingly, the strength at the axially outer end portion of the bulge portion is higher than that in the conventional art. Thus, even if the tube is pressed by the union nut in a state where the bulge portion is press-fitted into the end portion of the tube, it is possible to inhibit the axially outer end portion of the bulge portion from falling down toward the radially inner side (fluid flow passage side). As a result, the surface pressure between the contact surfaces of the axially outer end portion of the bulge portion and the tube is higher than that in the conventional art, so that it is possible to inhibit a fluid from entering between these contact surfaces.

(2) Preferably, the bulge portion has, in an inner circumferential surface thereof, a tapered surface inclined such that a diameter thereof gradually increases from the axially inner side toward an axially outer end thereof.

In this case, when the union nut presses the tube, even if the bulge portion falls down toward the radially inner side, it is possible to inhibit the inner circumferential surface of the bulge portion from protruding to the radially inner side. As a result, it is possible to inhibit the flow of the fluid in the fluid flow passage of the inner ring from being obstructed by the inner circumferential surface of the bulge portion.

(3) Preferably, the bulge portion has a chamfered portion formed at a corner portion formed by the tapered surface and the flat surface.

In this case, even if the fluid enters a recess formed between the corner portion of the bulge portion and the tube, the fluid in the recess easily flows to the fluid flow passage side due to the chamfered portion, so that it is possible to inhibit the fluid from remaining in the recess.

(4) Preferably, a thickness dimension in the radial direction at the axially outer end of the bulge portion is not less than 3% and not greater than 30% of a maximum thickness dimension in the radial direction of the bulge portion.

In this case, by setting the thickness dimension in the radial direction at the axially outer end of the bulge portion so as to be not less than 3% of the maximum thickness dimension in the radial direction of the bulge portion, the strength at the axially outer end portion of the bulge portion is further increased. Accordingly, when the union nut presses the tube, it is possible to further inhibit the axially outer end portion of the bulge portion from falling down toward the radially inner side. As a result, the surface pressure between the contact surfaces of the axially outer end portion of the bulge portion and the tube is further increased, so that it is possible to effectively inhibit the fluid from entering between these contact surfaces.

Moreover, by setting the thickness dimension in the radial direction at the axially outer end of the bulge portion so as to be not greater than 30% of the maximum thickness dimension in the radial direction of the bulge portion, it is possible to further inhibit the inner circumferential surface of the bulge portion from protruding to the radially inner side when the axially outer end portion of the bulge portion falls down toward the radially inner side. Accordingly, it is possible to effectively inhibit the flow of the fluid in the fluid flow passage of the inner ring from being obstructed by the inner circumferential surface of the bulge portion.

(5) A pipe joint of the present invention includes: a joint body having an external thread portion formed on an outer circumference thereof; a union nut having an internal thread portion formed on an inner circumference thereof and to be tightened to the external thread portion; and the inner ring according to any one of the above (1) to (4).

In the pipe joint of the present invention, in the inner ring, the bulge portion which is formed so as to be tapered from the axially inner side toward the axially outer end thereof has the flat surface formed at the axially outer end thereof and extending in the radial direction, so that the thickness in the radial direction at the axially outer end of the bulge portion can be larger than that in the conventional art. Accordingly, the strength at the axially outer end portion of the bulge portion is higher than that in the conventional art. Thus, even if the tube is pressed by the union nut in a state where the bulge portion is press-fitted into the end portion of the tube, it is possible to inhibit the axially outer end portion of the bulge portion from falling down toward the radially inner side (fluid flow passage side). As a result, the surface pressure between the contact surfaces of the axially outer end portion of the bulge portion and the tube is higher than that in the conventional art, so that it is possible to inhibit a fluid from entering between these contact surfaces.

### Advantageous Effects of the Invention

According to the present invention, it is possible to inhibit the axially outer end portion of the bulge portion from falling down toward the radially inner side.

### BRIEF DESCRIPTION OF DRAWINGS

FIG. 1 is an axial cross-sectional view of a pipe joint according to an embodiment of the present invention.

FIG. 2 is an axial cross-sectional view showing an inner ring of the pipe joint.

FIG. 3 is an enlarged cross-sectional view of a main part of FIG. 2.

### DETAILED DESCRIPTION

Next, preferred embodiments of the present invention will be described with reference to the accompanying drawings.

[Entire Configuration of Pipe Joint]

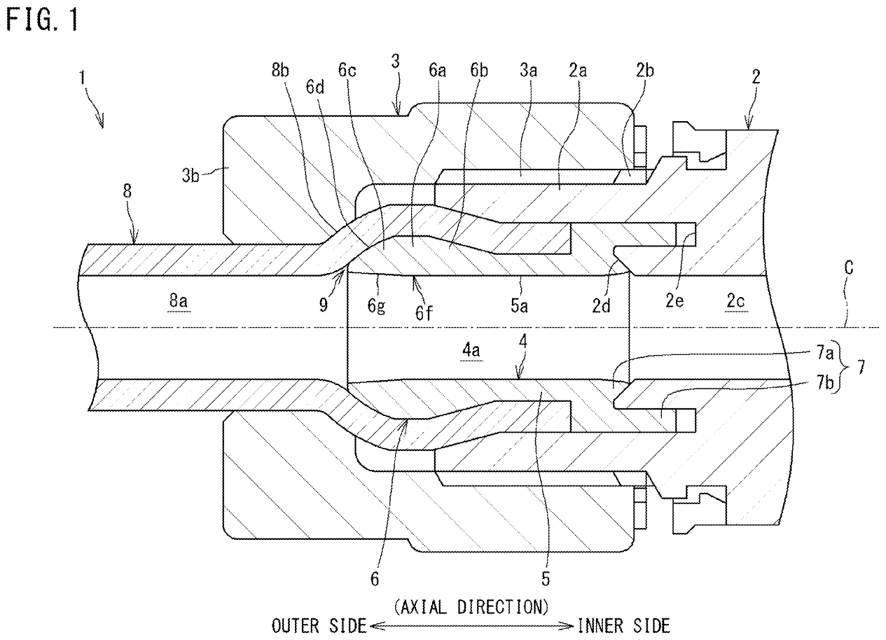

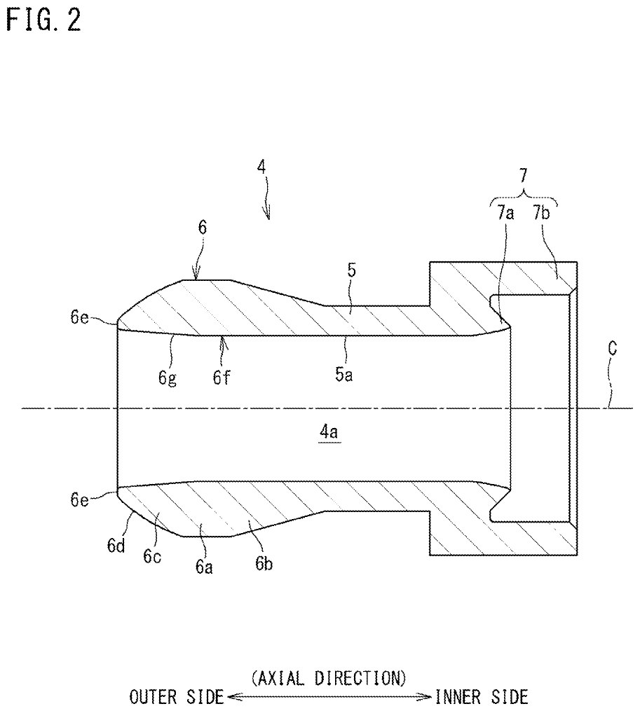

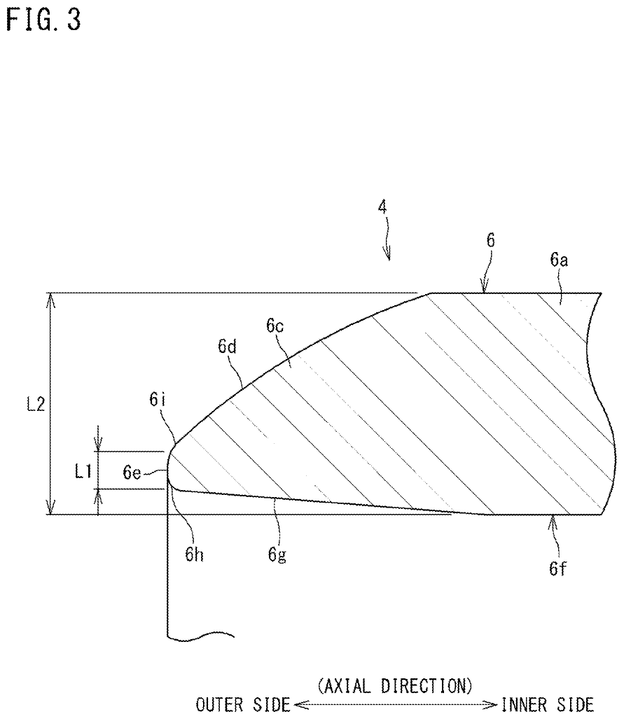

FIG. 1 is an axial cross-sectional view showing a pipe joint according to an embodiment of the present invention. In FIG. 1, a pipe joint 1 is used, for example, in a pipe path through which a chemical solution (fluid) used in a semiconductor manufacturing apparatus flows. The pipe joint 1 includes a joint body 2, a union nut 3, and an inner ring 4. Hereinafter, in the present embodiment, for convenience, the left side of FIG. 1 is referred to as an axially outer side, and the right side of FIG. 1 is referred to as an axially inner side (the same applies to FIG. 2 and FIG. 3).

The inner ring 4 is formed in a cylindrical shape, for example, from a synthetic resin material such as polyvinyl chloride (PVC), polypropylene (PP), polyethylene (PE), or a fluorine resin (perfluoroalkoxy alkane (PFA), polytetrafluoroethylene (PTFE), polyvinylidene fluoride (PVDF), or the like).

The inner ring 4 includes a body portion 5 formed in a cylindrical shape, a bulge portion 6 formed on the axially outer side of the body portion 5, and a sealing portion 7 formed on the axially inner side of the body portion 5. A fluid flow passage 4a is formed on the radially inner side of each of the body portion 5, the bulge portion 6, and the sealing portion 7 in the inner ring 4. The fluid flow passage 4a provides communication between a flow passage 8a formed inside a tube 8 and a flow passage 2c formed inside the joint body 2.

The bulge portion 6 is formed on the axially outer side of the body portion 5 so as to project toward the radially outer side. The bulge portion 6 is press-fitted into an end portion of the tube 8, which is made of a synthetic resin material (PFA or the like), to increase the diameter of the end portion of the tube 8. The bulge portion 6 will be described in detail later. The sealing portion 7 includes an annular primary sealing portion 7a and a cylindrical secondary sealing portion 7b.

The primary sealing portion 7a is formed so as to project from the radially inner side of an axially inner end portion of the body portion 5 toward the axially inner side. The outer circumferential surface of the primary sealing portion 7a is formed such that the diameter thereof gradually decreases from the axially outer end thereof toward the axially inner end thereof. The primary sealing portion 7a is press-fitted into a primary sealing groove 2d (described later) of the joint body 2. The secondary sealing portion 7b is formed so as to project from the radially outer side of the axially inner end portion of the body portion 5 toward the axially inner side. The secondary sealing portion 7b is press-fitted into a secondary sealing groove 2e (described later) of the joint body 2.

The joint body 2 is formed in a cylindrical shape, for example, from a synthetic resin material such as PVC, PP, PE, or a fluorine resin (PFA, PTFE, or the like). The inner diameter of the joint body 2 is set to substantially the same dimension as the inner diameter of the inner ring 4 such that the movement of the chemical solution is not hindered. A receiving portion 2a is formed at an end portion of the joint body 2. The sealing portion 7 of the inner ring 4 in which the bulge portion 6 is press-fitted into the end portion of the tube 8 is press-fitted to the inner circumference of the receiving portion 2a. Accordingly, the axially outer end portion of the joint body 2 is mounted on the outer circumference of the end portion of the tube 8. An external thread portion 2b is formed on the outer circumference of the receiving portion 2a.

The joint body 2 has the annular primary sealing groove 2d and the annular secondary sealing groove 2e which are formed on the radially inner side with respect to the receiving portion 2a. The primary sealing groove 2d is formed on the radially inner side of the joint body 2 in a tapered shape that is cut such that the diameter thereof gradually decreases from the axially outer end thereof toward the axially inner end thereof. The secondary sealing groove 2e is formed on the radially outer side with respect to the primary sealing groove 2d in the joint body 2.

The union nut 3 is formed in a cylindrical shape, for example, from a synthetic resin material such as PVC, PP, PE, or a fluorine resin (PFA, PTFE, or the like). The union nut 3 has an internal thread portion 3a formed on the inner circumference on the axially inner side thereof, and a pressing portion 3b formed on the axially outer side thereof so as to project toward the radially inner side. The internal thread portion 3a is tightened to the external thread portion 2b of the joint body 2. By the tightening, the union nut 3 is attached to the joint body 2, and an axially inner end portion of the pressing portion 3b presses a diameter-increased portion 8b, in the outer circumferential surface of the tube 8, whose diameter has been increased by the bulge portion 6 of the inner ring 4.

With the above configuration, when the internal thread portion 3a of the union nut 3 is tightened to the external thread portion 2b of the joint body 2, the primary sealing portion 7a and the secondary sealing portion 7b of the inner ring 4 are press-fitted into the primary sealing groove 2d and the secondary sealing groove 2e of the joint body 2, respectively. Accordingly, sealing performance at the connection portion between the inner ring 4 and the joint body 2 can be ensured. In addition, the pressing portion 3b of the union nut 3 can prevent coming-out of the tube 8 by pressing the diameter-increased portion 8b of the tube 8.

[Configuration of Bulge Portion]

FIG. 2 is an axial cross-sectional view showing the inner ring 4. In FIG. 1 and FIG. 2, the bulge portion 6 of the inner ring 4 has a maximum thickness portion 6a in which the thickness in the radial direction thereof is maximum, a first thickness change portion 6b formed on the axially inner side of the maximum thickness portion 6a, and a second thickness change portion 6c formed on the axially outer side of the maximum thickness portion 6a.

The maximum thickness portion 6a is formed over a predetermined length in the axial direction. The outer circumferential surface of the first thickness change portion 6b is formed such that the diameter thereof gradually decreases from the axially inner end of the maximum thickness portion 6a toward the axially inner side. Accordingly, the first thickness change portion 6b is formed such that the thickness in the radial direction thereof gradually decreases from the axially inner end of the maximum thickness portion 6a toward the axially inner side. The axially inner end of the first thickness change portion 6b is connected to the body portion 5. In the present embodiment, the outer circumferential surface of the first thickness change portion 6b is formed in a linear shape in a cross-sectional view, but may be formed so as to be inclined in a curved shape in a cross-sectional view.

An outer circumferential surface 6d of the second thickness change portion 6c is formed such that the diameter thereof gradually decreases from the axially outer end of the maximum thickness portion 6a toward the axially outer side. In the present embodiment, the outer circumferential surface 6d of the second thickness change portion 6c is formed so as to be inclined in a curved shape in a cross-sectional view. Accordingly, the second thickness change portion 6c is formed such that the thickness in the radial direction thereof gradually decreases from the axially inner end thereof toward the axially outer end thereof, that is, the second thickness change portion 6c is tapered. The outer circumferential surface 6d of the second thickness change portion 6c may be formed in a linear shape in a cross-sectional view.

FIG. 3 is an enlarged cross-sectional view of a main part of FIG. 2. In FIG. 2 and FIG. 3, a flat surface 6e is formed at the axially outer end of the second thickness change portion 6c in the bulge portion 6 so as to extend in the radial direction. Here, “extending in the radial direction” includes not only the case of extending along a direction orthogonal to an axis C of the inner ring 4, but also the case of extending along a direction slightly inclined with respect to the orthogonal direction.

In the case where the flat surface 6e is inclined with respect to the orthogonal direction such that the radially inner end of the flat surface 6e is located on the axially outer side with respect to the radially outer end thereof, an inclination angle of the flat surface 6e with respect to the orthogonal direction is preferably not less than 1° and not greater than 10°.

In the case where the flat surface 6e is inclined with respect to the orthogonal direction such that the radially inner end of the flat surface 6e is located on the axially inner side with respect to the radially outer end thereof, the inclination angle of the flat surface 6e with respect to the orthogonal direction is preferably not less than 1° and not greater than 20°.

As described above, in the bulge portion 6 of the inner ring 4, the second thickness change portion 6c which is formed so as to be tapered from the axially inner end thereof toward the axially outer end thereof has the flat surface 6e formed at the axially outer end thereof and extending in the radial direction, so that the thickness in the radial direction (thickness dimension L1 described later) at the axially outer end of the second thickness change portion 6c can be larger than that in the conventional art. Accordingly, the strength at an axially outer end portion (second thickness change portion 6c) of the bulge portion 6 is higher than that in the conventional art. Thus, when tightening the union nut 3 to the joint body 2 in a state where the bulge portion 6 is press-fitted into the end portion of the tube 8, even if the union nut 3 presses the diameter-increased portion 8b of the tube 8, it is possible to inhibit the axially outer end portion of the bulge portion 6 from falling down toward the radially inner side (fluid flow passage 4a side). As a result, the surface pressure between the contact surfaces of the axially outer end portion of the bulge portion 6 and the tube 8 is higher than that in the conventional art, so that it is possible to inhibit the chemical solution from entering between these contact surfaces.

A tapered surface 6g is formed in an inner circumferential surface 6f of the bulge portion 6 so as to be inclined such that the diameter thereof gradually increases from a middle portion in the axial direction of the maximum thickness portion 6a toward the axially outer end of the second thickness change portion 6c. The tapered surface 6g in the present embodiment is inclined such that, when the union nut 3 presses the diameter-increased portion 8b of the tube 8, even if the second thickness change portion 6c falls down toward the radially inner side, the tapered surface 6g does not protrude to the radially inner side with respect to an inner circumferential surface 5a of the body portion 5 (see FIG. 1).

Accordingly, when the union nut 3 presses the diameter-increased portion 8b of the tube 8, even if the second thickness change portion 6c of the bulge portion 6 falls down toward the radially inner side, it is possible to inhibit the inner circumferential surface 6f of the bulge portion 6 from protruding to the radially inner side with respect to the inner circumferential surface 5a of the body portion 5. As a result, it is possible to inhibit the flow of the chemical solution in the fluid flow passage 4a of the inner ring 4 from being obstructed by the inner circumferential surface 6f of the bulge portion 6. The tapered surface 6g of the present embodiment is formed so as to be inclined in a linear shape in a cross-sectional view, but may be formed so as to be inclined in a curved shape.

A chamfered portion 6h is formed at a corner portion (first corner portion) formed by the flat surface 6e and the tapered surface 6g of the bulge portion 6. The chamfered portion 6h of the present embodiment is formed, for example, by performing R-chamfering on the first corner portion. Accordingly, as shown in FIG. 1, when the union nut 3 presses the diameter-increased portion 8b of the tube 8, even if the chemical solution enters a recess 9 formed between the corner portion of the bulge portion 6 and the inner circumferential surface of the tube 8, the chemical solution in the recess 9 easily flows to the fluid flow passage 4a side along the chamfered portion 6h. As a result, it is possible to inhibit the chemical solution from remaining in the recess 9. The chamfered portion 6h may be formed by performing C-chamfering on the first corner portion.

Referring back to FIG. 3, a chamfered portion 6i is formed at a corner portion (second corner portion) formed by the flat surface 6e and the outer circumferential surface 6d of the second thickness change portion 6c in the bulge portion 6. The chamfered portion 6i of the present embodiment is formed, for example, by performing R-chamfering on the second corner portion. The chamfered portion 6i may be formed by performing C-chamfering on the second corner portion. In addition, the chamfered portion 6i does not necessarily need to be formed at the corner portion formed by the flat surface 6e and the outer circumferential surface 6d.

The thickness dimension L1 in the radial direction at the axially outer end of the bulge portion 6 is set so as to be not less than 3% and not greater than 30% of a maximum thickness dimension L2 in the radial direction of the bulge portion 6. In order to improve the falling-down inhibition effect as described above, the thickness dimension L1 is preferably set so as to be not less than 5% and not greater than 20% of the maximum thickness dimension L2. The maximum thickness dimension L2 is the thickness dimension in the radial direction of the maximum thickness portion 6a of the bulge portion 6. The “thickness dimension in the radial direction” at the axially outer end means the radial dimension from the radially outer end (in the present embodiment, the point of intersection of an extension line of the flat surface 6e and an extension line of the outer circumferential surface 6d) to the radially inner end (in the present embodiment, the point of intersection of the extension line of the flat surface 6e and an extension line of the tapered surface 6g) at the axially outer end of the bulge portion 6.

By setting the thickness dimension L1 so as to be not less than 3% of the maximum thickness dimension L2, the strength at the axially outer end portion of the bulge portion 6 is further increased. Accordingly, when the union nut 3 presses the diameter-increased portion 8b of the tube 8, it is possible to further inhibit the axially outer end portion of the bulge portion 6 from falling down toward the radially inner side. As a result, the surface pressure between the contact surfaces of the axially outer end portion of the bulge portion 6 and the tube 8 is further increased, so that it is possible to effectively inhibit the chemical solution from entering between these contact surfaces.

By setting the thickness dimension L1 so as to be not greater than 30% of the maximum thickness dimension L2, it is possible to further inhibit the inner circumferential surface 6f of the bulge portion 6 from protruding to the radially inner side when the second thickness change portion 6c of the bulge portion 6 falls down toward the radially inner side. Accordingly, it is possible to effectively inhibit the flow of the chemical solution in the fluid flow passage 4a of the inner ring 4 from being obstructed by the inner circumferential surface 6f of the bulge portion 6.

[Others]

The pipe joint and the inner ring of the present invention can also be applied to the liquid crystal/organic EL field, the medical/pharmaceutical field, automotive-related fields, etc., in addition to a semiconductor manufacturing apparatus.

The embodiments disclosed herein are merely illustrative in all aspects and should not be recognized as being restrictive. The scope of the present invention is defined by the scope of the claims rather than the meaning described above, and is intended to include meaning equivalent to the scope of the claims and all modifications within the scope.

### REFERENCE SIGNS LIST

1 pipe joint
2 joint body
2b external thread portion
3 union nut
3a internal thread portion
4 inner ring
6 bulge portion
6e flat surface
6f inner circumferential surface
6g tapered surface
6h chamfered portion
L1 thickness dimension
L2 maximum thickness dimension

1. An inner ring comprising a bulge portion formed at an axially outer end portion thereof so as to project toward a radially outer side, and to be press-fitted into an end portion of a tube, the inner ring having a fluid flow passage formed on a radially inner side of the bulge portion, wherein
the bulge portion is formed so as to be tapered from an axially inner side toward an axially outer end thereof in an axial cross-sectional view, and has a flat surface formed at the axially outer end thereof and extending in a radial direction.

2. The inner ring according to claim 1, wherein the bulge portion has, in an inner circumferential surface thereof, a tapered surface inclined such that a diameter thereof gradually increases from the axially inner side toward an axially outer end thereof.

3. The inner ring according to claim 2, wherein the bulge portion has a chamfered portion formed at a corner portion formed by the tapered surface and the flat surface.

4. The inner ring according to claim 1, wherein a thickness dimension in the radial direction at the axially outer end of the bulge portion is not less than 3% and not greater than 30% of a maximum thickness dimension in the radial direction of the bulge portion.

5. A pipe joint comprising:
a joint body having an external thread portion formed on an outer circumference thereof;
a union nut having an internal thread portion formed on an inner circumference thereof and to be tightened to the external thread portion; and
the inner ring according to claim 1.
